(19) United States
(12) Patent Application Publication
(10) Pub. No.: US 2026/0070220 A1
(43) Pub. Date: Mar. 12, 2026

(54) INFORMATION PROCESSING METHOD, INFORMATION PROCESSING APPARATUS, AND NON-TRANSITORY COMPUTER-READABLE STORAGE MEDIUM

(71) Applicant: Panasonic Intellectual Property Management Co., Ltd., Osaka (JP)

(72) Inventors: KENTARO IIO, Fukuoka (JP); TAKAHIRO YAMAGUCHI, Osaka (JP)

(21) Appl. No.: 19/392,216

(22) Filed: Nov. 18, 2025

Related U.S. Application Data
(63) Continuation of application No. PCT/JP2024/004349, filed on Feb. 8, 2024.

(30) Foreign Application Priority Data
Jun. 19, 2023 (JP) 2023-100276

(51) Int. Cl. B25J 9/16

(52) U.S. Cl. CPC B25J 9/1653; B25J 9/1697

(57) ABSTRACT

An information processing method according to an aspect of the present disclosure includes obtaining first information indicating an image capture range of a first camera provided for a robot that autonomously moves and that captures an image of a predetermined area, and detecting an abnormality in the robot on a basis of the first information.

### BACKGROUND

### 1. Technical Field

The present disclosure relates to an information processing method, an information processing apparatus, and a non-transitory computer-readable storage medium.

### 2. Description of the Related Art

There are technologies for capturing images of intruders or the like using drones equipped with cameras for security purposes (for example, see Japanese Unexamined Patent Application Publication No. 2020-154966).

Japanese Unexamined Patent Application Publication No. 2020-154966 discloses an apparatus that determines a destination to which a control body including image capture means and moving means is to be moved using the moving means, in order to capture, using the image capture means, an image of a target object that is moving within a space where obstacles are present.

### SUMMARY

For example, a robot that is a control body including image capture means and moving means autonomously moves and captures images of predetermined positions and targets. If the robot is subjected to a cyber attack or the like at this time, the robot might exhibit abnormal behavior such as a failure to capture an image of a position whose image needs to be captured.

One non-limiting and exemplary embodiment provides an information processing method and the like capable of detecting abnormal behavior of a robot.

In one general aspect, the techniques disclosed here feature an information processing method including obtaining first information indicating an image capture range of a first camera provided for a robot that autonomously moves and that captures an image of a predetermined area, and detecting an abnormality in the robot on a basis of the first information.

According to the present disclosure, an information processing method and the like capable of detecting abnormal behavior of a robot can be provided.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating a security system according to an embodiment;

FIG. 2 is a block diagram illustrating a functional configuration of a security system according to the embodiment;

FIG. 3 is a diagram illustrating a first example of monitoring according to the embodiment;

FIG. 4 is another diagram illustrating the first example of the monitoring according to the embodiment;

FIG. 5 is a diagram illustrating a second example of the monitoring according to the embodiment;

FIG. 6 is another diagram illustrating the second example of the monitoring according to the embodiment;

FIG. 7 is a flowchart illustrating a first example of a processing procedure of an abnormality detection system according to the embodiment;

FIG. 8 is a flowchart illustrating a specific example of a process for determining an abnormality performed by the abnormality detection system according to the embodiment;

FIG. 9 is another flowchart illustrating the specific example of the process for determining an abnormality performed by the abnormality detection system according to the embodiment;

FIG. 10 is another flowchart illustrating the specific example of the process for determining an abnormality performed by the abnormality detection system according to the embodiment;

FIG. 11 is a flowchart illustrating a second example of the processing procedure of the abnormality detection system according to the embodiment;

FIG. 12 is another flowchart illustrating the second example of the processing procedure of the abnormality detection system according to the embodiment;

FIG. 13 is a diagram illustrating a third example of the monitoring according to the embodiment;

FIG. 14 is another diagram illustrating the third example of the monitoring according to the embodiment;

FIG. 15 is another diagram illustrating the third example of the monitoring according to the embodiment;

FIG. 16 is a diagram illustrating a fourth example of the monitoring according to the embodiment;

FIG. 17 is another diagram illustrating the fourth example of the monitoring according to the embodiment;

FIG. 18 is another diagram illustrating the fourth example of the monitoring according to the embodiment;

FIG. 19 is a flowchart illustrating a third example of the processing procedure of the abnormality detection system according to the embodiment;

FIG. 20 is another flowchart illustrating the third example of the processing procedure of the abnormality detection system according to the embodiment;

FIG. 21 is a flowchart illustrating another specific example of the process for determining an abnormality performed by the abnormality detection system according to the embodiment; and

FIG. 22 is a flowchart illustrating a processing procedure of an information processing apparatus according to the embodiment.

### DETAILED DESCRIPTIONS

An embodiment will be specifically described hereinafter with reference to the drawings.

The embodiment described hereinafter is a general or specific example. Values, shapes, materials, components, arrangement positions and connection modes of the components, steps, order of the steps, and the like mentioned in the following embodiment are examples, and not intended to limit the present disclosure. Among the components in the following embodiment, ones that are not described in the independent claims, which define broadest concepts, will be described as optional components. The drawings are not necessarily strict illustrations. In the drawings, substantially the same components are given the same reference numerals, and redundant description thereof might be omitted or simplified.

In the present specification, ordinal numbers such as “first” and “second” do not mean the number or order of components unless otherwise specified, but are used to avoid confusion between components of the same type and distinguish such components from each other.

In the present specification, when descriptions “larger than or equal to a threshold” and “smaller than the threshold” are provided in contrast from each other, for example, a distinction is made at the threshold, and these description may mean “larger than the threshold” and “smaller than or equal to threshold”, respectively, instead.

### Embodiment

### Configuration

First, configuration of an abnormality detection system according to an embodiment will be described.

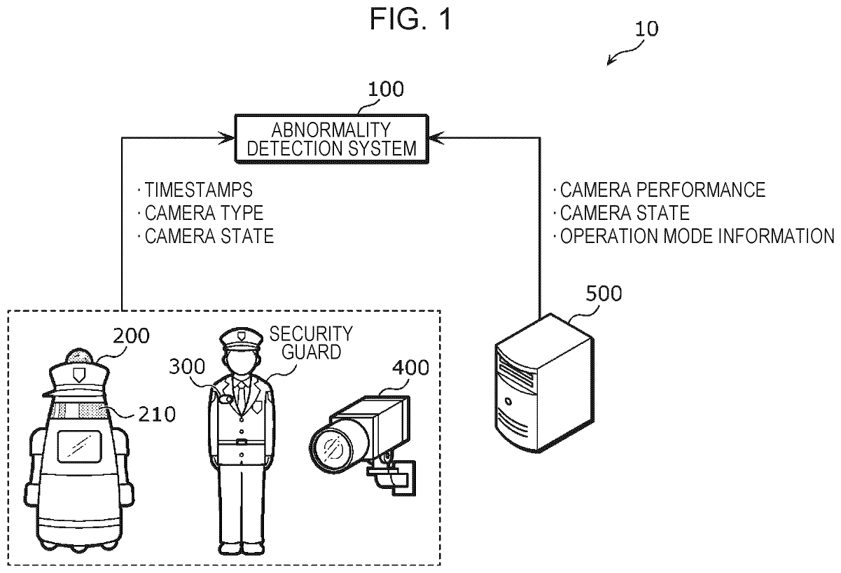

FIG. 1 is a diagram illustrating a security system 10 according to the embodiment.

The security system 10 is a system that secures a predetermined area to be monitored, such as an inside of a building. The security system 10 monitors the predetermined area to be monitored on the basis of images of regions to be monitored obtained from a robot camera 210 provided for a robot 200, a security guard camera 300 provided for a security guard, a fixed camera 400 fixed on a building or the like, and the like.

In the security system 10, an abnormality detection system 100 detects an abnormality in the robot 200. Specifically, the abnormality detection system 100 obtains information indicating performance and states of the robot camera 210, the security guard camera 300, and the fixed camera 400 and information indicating an operation mode of the robot 200 from the robot 200 that moves (autonomously moves) and captures images and a server apparatus 500 that manages the robot 200, and determines whether the robot 200 is behaving (operating) abnormally on the basis of the obtained information.

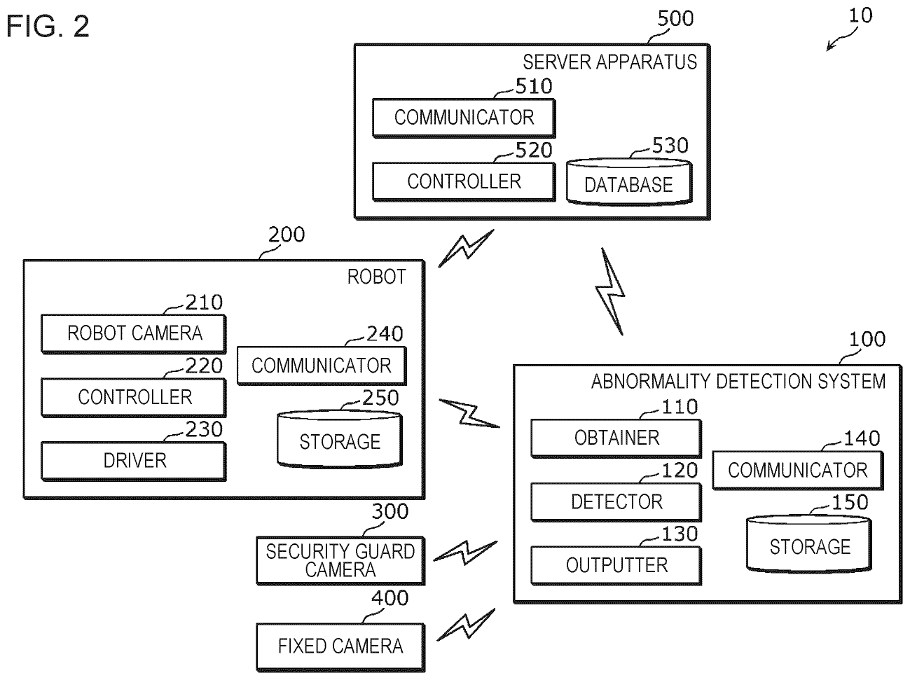

FIG. 2 is a block diagram illustrating a functional configuration of the security system 10 according to the embodiment.

The security system 10 includes, for example, the abnormality detection system 100, the server apparatus 500, one or more robots 200, one or more security guard cameras 300, and one or more fixed cameras 400.

The security system 10 may include a plurality of robots 200. The security system 10 may include a plurality of security guard cameras 300. The security system 10 may include a plurality of fixed cameras 400. The security system 10 may include only one of the security guard camera 300 or the fixed camera 400.

The abnormality detection system 100 is a system that detects an abnormality in the robot 200. The abnormality detection system 100 is an example of an information processing apparatus.

The abnormality detection system 100 is achieved by, for example, a communication interface for communicating with each device included in the security system 10, a nonvolatile memory storing programs, a volatile memory that is a temporary storage area for executing programs, input/output ports for transmitting and receiving signals, a processor that executes programs, and the like. The communication interface may be achieved by an antenna and a wireless communication circuit or the like so that wireless communication becomes possible, or may be achieved by a connector or the like to which a communication line for performing wired communication is connected.

A communication standard used for the communication in the security system 10 may be arbitrarily determined.

The abnormality detection system 100 includes an obtainer 110, a detector 120, an outputter 130, a communicator 140, and a storage 150.

The obtainer 110 is a processing unit that obtains various types of information. For example, the obtainer 110 obtains various types of information from the robot 200, the security guard camera 300, the fixed camera 400, and the server apparatus 500 via the communicator 140.

The obtainer 110 obtains images captured by the apparatuses, timestamps, camera types, and camera states, for example, from the robot 200, the security guard camera 300, and the fixed camera 400. The obtainer 110 also obtains operation mode information indicating the camera performance, the camera states, and the operation mode of the robot 200 from the server apparatus 500.

The timestamps are information indicating image capture timings of the cameras, periods in which the cameras have captured images, or the like.

The camera types (more specifically, information indicating camera types) are information indicating camera types, such as predetermined identifiers uniquely indicating cameras.

The camera states (more specifically, information indicating camera states) are dynamic information regarding image capture ranges of the cameras. For example, the camera states are information indicating positions and directions (image capture directions) of the cameras. For example, the obtainer 110 obtains the camera state of the robot camera 210 from the robot camera 210, the camera state of the security guard camera 300 from the security guard camera 300, and the camera state of the fixed camera 400 from the server apparatus 500.

The camera performance (more specifically, information indicating camera performance) is static information regarding image capture ranges of the cameras. For example, the camera performance is information indicating performance of the cameras such as fields of views and focal lengths of the cameras.

The timestamps, the camera type, the camera state, and the camera performance of the robot camera 210 are examples of information included in first information.

The timestamps, the camera type, the camera state, and the camera performance of each of the security guard camera 300 and the fixed camera 400 are examples of information included in second information.

For example, the obtainer 110 regularly and repeatedly obtains the timestamps and the camera states from the robot camera 210, the security guard camera 300, and the fixed camera 400.

The operation mode indicates an operation state of the robot 200. The robot 200 can perform various operations in accordance with conditions as an image capture position, an image capture direction, an image capture timing, and/or a movement route are determined in accordance with the conditions. In the present embodiment, the operation mode information indicates an operation and a state of the robot 200, such as how the robot 200 autonomously moves and captures an image of the predetermined area.

The operation mode information is information indicating the operation mode of the robot 200. Specifically, the operation mode information is information indicating an operation mode at a time when the robot 200 has captured an image.

The robot 200 performs, for example, a sentry operation, a patrolling operation, a mobile sentry operation, and an emergency response operation.

The sentry operation is an operation that intensively monitors a specific location. Specifically, in the sentry operation, the robot 200 captures an image of a specific location. In the sentry operation, the robot 200 may move and capture an image of the specific location, or may continue to capture an image of the specific location without moving. “Move and capture an image” may mean capturing an image while moving or capturing an image after temporarily stopping.

The patrolling operation is an operation for moving and monitoring along a predetermined route. Specifically, in the patrolling operation, the robot 200 moves along a predetermined route and captures images.

The mobile sentry operation is an operation for monitoring an important location while moving. Specifically, in the mobile sentry operation, the robot 200 captures an image while moving to eliminate blind spots. As described above, a plurality of cameras captures images of the predetermined area to be monitored. The robot 200 and the security guard capture images while moving. The robot 200, therefore, captures images while moving to eliminate blind spots, that is, areas whose images have not been captured for a long time, in accordance with the image capture ranges of the cameras other than the robot camera 210 (for example, the security guard camera 300 and the fixed camera 400).

The cameras included in the security system 10 other than the robot camera 210 will also be referred to as “other cameras”. The other cameras are examples of a second camera.

The emergency response operation is an operation performed when an unexpected event, such as detection of presence of a suspicious object or a suspicious person, has occurred. In the emergency response operation, for example, a specific location is intensively monitored as in the sentry operation.

A state of the robot 200 when performing the sentry operation and the emergency response operation will be referred to as a “first operation mode”. Specifically, the first operation mode is an operation mode in which the robot 200 continues to capture, using the robot camera 210, an image of at least one of a plurality of sections (area sections) included in the predetermined area.

A state of the robot 200 when performing the mobile sentry operation will be referred to as a “second operation mode”. Specifically, the second operation mode is an operation mode in which the robot 200 captures, using the robot camera 210, an image of the predetermined area in accordance with the image capture ranges of the cameras (second cameras) provided outside the robot 200.

The robot 200 thus operates in, for example, one of a plurality of operations modes including the first operation mode and the second operation mode to capture an image of the predetermined area using the robot camera 210. The robot 200 thus secures the predetermined area.

The obtainer 110 may obtain these pieces of information from any of the robot 200, the security guard camera 300, the fixed camera 400, and the server apparatus 500. These pieces of information may be stored in the storage 150 in advance.

As described above, the obtainer 110 obtains, for example, the first information indicating the image capture range of the robot camera 210 provided for the robot 200, which autonomously moves and captures images of the predetermined area. The obtainer 110 also obtains, for example, the second information indicating the image capture ranges of the other cameras. The obtainer 110 also obtains, for example, the operation mode information indicating the operation mode of the robot 200.

The first information may be information directly indicating the image capture range, or may be information indirectly indicating the image capture range, such as information for calculating the image capture range. For example, when the obtainer 110 has obtained a timestamp, a camera type, a camera state, and camera performance from the robot 200 or the server apparatus 500, the obtainer 110 may obtain the first information by calculating the image capture range of the robot camera 210 on the basis of the timestamp, the camera type, the camera state, and the camera performance. The same holds for the second information.

For example, the first information includes first period information indicating the image capture range of the robot camera 210 in a first period and second period information indicating the image capture range of the robot camera 210 in a second period, which is different from the first period. The first period information and the second period information are, for example, information including timestamps. The second information may include first period information indicating the image capture ranges of the other cameras in the first period and second period information indicating the image capture ranges of the other cameras in the second period, which is different from the first period. The first period and the second period have, for example, the same length of time. The length of time of the first and second periods may be arbitrarily determined.

The detector 120 is a processing unit that detects an abnormality in the robot 200. Specifically, the detector 120 determines whether an abnormality has occurred in the robot 200 on the basis of information regarding the robot 200.

For example, the detector 120 detects an abnormality in the robot 200 on the basis of the first information, or more specifically, on the basis of the image capture range of the robot camera 210 indicated by the first information. Alternatively, for example, the detector 120 detects an abnormality in the robot 200 on the basis of the first information and the operation mode information. That is, for example, the detector 120 detects an abnormality in the robot 200 by a method according to the operation mode of the robot 200. For example, the detector 120 determines the operation mode of the robot 200 on the basis of the operation mode information, and if the determined operation mode is the first operation mode (that is, the robot 200 is operating in the first operation mode), the detector 120 detects an abnormality in the robot 200 by a first abnormality detection method, and if the determined operation mode is the second operation mode, which is different from the first operation mode, the detector 120 detects an abnormality in the robot 200 by a second abnormality detection method, which is different from the first abnormality detection method. A specific process performed by the detector 120 will be described later.

The outputter 130 is a processing unit that outputs various types of information. For example, if the detector 120 detects an abnormality in the robot 200, that is, if the detector 120 determines that an abnormality has occurred in the robot 200, the outputter 130 outputs information indicating that an abnormality has occurred in the robot 200. A notification device that has obtained the information notifies the user who uses the security system 10 of the information indicating that an abnormality has occurred in the robot 200.

It is sufficient that the notification device can notify the user of an abnormality that has occurred in the robot 200. The notification device is, for example, a display device that is not illustrated, such as a display, and/or an audio device such as a speaker.

The processing units such as the obtainer 110, the detector 120, and the outputter 130 are achieved, for example, by a memory and a processor, such as a central processing unit (CPU), that executes a control program stored in the memory. The memory included in these processing units may be achieved by a common memory or may be achieved by one or more independent memories. The processor included in these processing units may be achieved by a common processor, or may be achieved by one or more independent processors.

The communicator 140 is a communication interface for communicating with the server apparatus 500, the robot 200, the security guard camera 300, and the fixed camera 400. The communicator 140 may be achieved by an antenna and a wireless communication circuit or the like for performing wireless communication, or may be achieved by a connector or the like to which a communication line for performing wired communication is connected.

The storage 150 is a storage device storing various types of information including thresholds. The storage 150 is achieved, for example, by a storage device such as a semiconductor memory or a hard disk drive (HDD).

The robot 200 is a mobile body that autonomously moves and captures images of the predetermined area. More specifically, the robot 200 secures the predetermined area by capturing images of the predetermined area using the robot camera 210 provided for the robot 200 while autonomously moving.

The robot 200 includes the robot camera 210, a controller 220, a driver 230, a communicator 240, and a storage 250.

The robot camera 210 is a camera that is provided for the robot 200 and that captures images of the predetermined area. The robot 200 may include one robot camera 210 or a plurality of robot cameras 210.

The controller 220 is a processing unit that controls the robot 200. For example, the controller 220 obtains operation mode information from the server apparatus 500 via the communicator 240 and controls the robot 200 such that the robot 200 operates in an operation mode indicated by the obtained operation mode information. For example, the controller 220 controls the robot camera 210 and the driver 230 in accordance with the operation mode. For example, the controller 220 transmits a timestamp, the camera state of the robot camera 210, and the like to the abnormality detection system 100 via the communicator 240.

The controller 220 is achieved, for example, by a memory and a processor, such as a CPU, that executes a control program stored in the memory.

The driver 230 is a driving mechanism, such as tires, for moving the robot 200.

The communicator 240 is a communication interface for communicating with the abnormality detection system 100 and the server apparatus 500. The communicator 240 may be achieved by an antenna and a wireless communication circuit or the like for performing wireless communication, or may be achieved by a connector or the like to which a communication line for performing wired communication is connected.

The storage 250 is a storage device storing various types of information including the camera type of the robot camera 210 and the camera performance of the robot camera 210. The storage 250 is achieved, for example, by a storage device such as a semiconductor memory or an HDD.

The server apparatus 500 is a computer storing information regarding the devices included in the security system 10. For example, the server apparatus 500 is achieved by a communication interface for communicating with the devices included in the security system 10, a nonvolatile memory storing programs, a volatile memory that is a temporary storage area for executing programs, input/output ports for transmitting and receiving signals, a processor that executes programs, and the like. The communication interface may be achieved, for example, by an antenna and a wireless communication circuit or the like for enabling wireless communication, or may be achieved by a connector or the like to which a communication line for performing wired communication is connected.

The server apparatus 500 includes a communicator 510, a controller 520, and a database 530.

The communicator 510 is a communication interface for communicating with the abnormality detection system 100 and the robot 200. The communicator 510 may be achieved by an antenna and a wireless communication circuit or the like for performing wireless communication, or may be achieved by a connector or the like to which a communication line for performing wired communication is connected.

The controller 520 is a processing unit that controls the server apparatus 500. For example, the controller 520 transmits operation mode information to the robot 200 via the communicator 510 to operate the robot 200 in an operation mode indicated by the operation mode information. For example, the controller 520 transmits, to the abnormality detection system 100 via the communicator 510, the camera performance of the fixed camera 400 and the like and the operation mode information indicating the operation mode of the robot 200.

The controller 520 is achieved, for example, by a memory and a processor, such as a CPU, that executes a control program stored in the memory.

The database 530 is a storage device storing various types of information (database) including camera performance. The database 530 is achieved, for example, by a semiconductor memory or an HDD.

### Processing Procedures

Next, processing procedures of the abnormality detection system 100 will be described.

### First Operation Mode

First, an operation of the abnormality detection system 100 in a case where the robot 200 is operating in the first operation mode will be described.

When the robot 200 is operating in the first operation mode, for example, the detector 120 detects an abnormality in the robot 200 on the basis of the first period information and the second period information. For example, the detector 120 determines whether an abnormality has occurred in the robot 200 on the basis of the image capture range of the robot camera 210 in the first period indicated by the first period information and the image capture range of the robot camera 210 in the second period indicated by the second period information.

When the robot 200 is operating in the first operation mode, for example, the detector 120 calculates, based on the first information, a section monitoring level (also referred to as a robot area section monitoring level) indicating a ratio of a period for which the robot camera 210 has captured images of each of a plurality of sections included in the predetermined area to a predetermined period, and detects an abnormality in the robot 200 on the basis of the section monitoring level.

The number, area, and shapes of sections included in the predetermined area may be arbitrarily determined. In the present embodiment, the predetermined area is divided into a plurality of sections in advance.

The predetermined period may be arbitrarily determined in advance.

The section monitoring level is a ratio of a section whose images have been captured by a single robot 200 (for example, one of a plurality of robots 200 when the security system 10 includes the plurality of robots 200) in a predetermined period, and calculated from a ratio of the section included in a robot image capture range of the single robot 200 in the predetermined period.

The robot image capture range refers to the sum of image capture ranges of all of one or more robot cameras 210 included in the robot 200. That is, the robot image capture range is a range obtained by overlapping the image capture ranges of the one or more robot cameras included in the robot 200.

For example, when any of the one or more robot cameras 210 included in the robot 200 has captured 10 images in the predetermined period and six of the images include a predetermined section, that is, an image of the predetermined section has been captured six times out of 10, the robot area section monitoring level is calculated as 60%.

When the robot 200 includes a plurality of robot cameras 210 and all the robot cameras 210 capture images at the same timing, the number of times that all the robot cameras 210 have captured images may be counted as the number of times that the robot 200 has captured images.

In the following description, a section monitoring level calculated from a ratio of a section whose images have been captured by a single camera (for example, one of a plurality of robot cameras 210 when the robot 200 includes the plurality of robot cameras 210) in the predetermined period, that is, a ratio of the section included in a camera image capture range of the single camera in the predetermined period, will be referred to as a camera section monitoring level.

For example, when a single camera has captured 10 images in the predetermined period and six of the images include a predetermined section, that is, an image of the predetermined section has been captured six times out of 10, the camera section monitoring level is calculated as 60%.

The camera image capture range refers to an image capture range of a single camera. The camera image capture range is calculated, for example, on the basis of camera performance and a camera state. For example, the robot image capture range is calculated by overlapping the image capture ranges of the one or more robot cameras provided for the robot 200.

For example, the detector 120 calculates, on the basis of the first information, a robot area coverage ratio indicating a ratio of an image capture range of the robot camera 210 to area of the predetermined area, and detects an abnormality in the robot 200 on the basis of a robot area coverage ratio.

The robot area coverage ratio refers to a ratio of area covered by images that have been captured by the robot 200 to the area of the predetermined area in the predetermined period. The robot area coverage ratio is calculated from a ratio of a range in which the robot image capture range of a single robot 200 overlaps the predetermined area in the predetermined period to the predetermined area.

When the robot 200 is operating in the first operation mode, for example, the detector 120 determines that the robot 200 is normal if the robot area coverage ratio is lower than a first threshold, and determines that the robot 200 is abnormal if the robot area coverage ratio is higher than or equal to the first threshold.

The first threshold may be arbitrarily determined, and is not particularly limited. Information indicating the first threshold is, for example, stored in the storage 150 in advance.

The first threshold is an example of a robot area coverage ratio threshold.

The robot area coverage ratio threshold is a threshold used by the detector 120 to determine, using the robot area coverage ratio of the robot 200, whether the robot 200 is monitoring a sufficient range in the predetermined area.

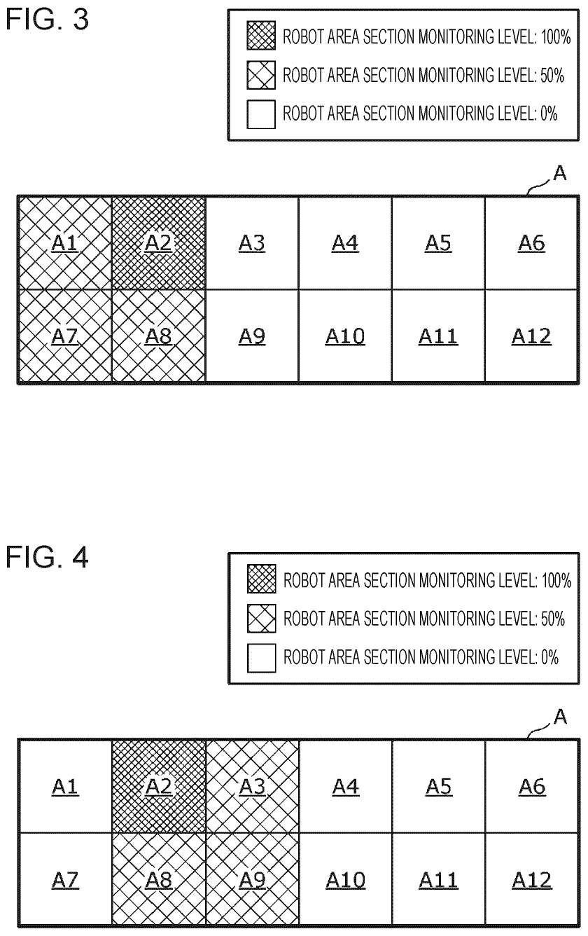

FIGS. 3 and 4 are diagrams illustrating a first example of monitoring according to the embodiment. Specifically, FIG. 3 is a diagram illustrating the robot area section monitoring levels in the first period. FIG. 4 is a diagram illustrating the robot area section monitoring levels in the second period after images are captured as in the example illustrated in FIG. 3.

As illustrated in FIGS. 3 and 4, in this example, a predetermined area A is divided into 12 sections A1 to A12 in advance. For example, the robot 200 captures images of at least one of the sections A1 to A12 while moving within the predetermined area A. For example, the robot 200 simultaneously captures an image of a plurality of sections such as the sections A1 and A2 or captures an image of only one section such as the section A2.

In the example illustrated in FIG. 3, in the first period, the robot area section monitoring level of the section A2 is 100%, the robot area section monitoring levels of the sections A1, A7, and A8 are 50%, and the robot area section monitoring levels of the sections A3, A4, A5, A6, A9, A10, A11, and A12 are 0%. That is, in the first period, the robot 200 invariably captures images of the section A2, captures images of the sections A1, A7, and A8 every other time, and does not capture images of the sections A3, A4, A5, A6, A9, A10, A11, and A12. When the robot 200 has generated images by performing image capture 10 times in the first period, that is, has generated 10 images in the first period, for example, all of the 10 images show the section A2, five of the 10 images show the sections A1, A7, and A8, and none of the 10 images shows the sections A3, A4, A5, A6, A9, A10, A11, and A12.

In the example illustrated in FIG. 4, in the second period, the robot area section monitoring level of the section A2 is 100%, the robot area section monitoring levels of the sections A3, A8, and A9 are 50%, and the robot area section monitoring levels of the sections A1, A4, A5, A6, A7, A10, A11, and A12 are 0%.

In the first operation mode, for example, when normal, the robot 200 operates in such a way as to capture more images of a specific section, such as the section A2, where there is a suspicious object or a security gate, compared to other sections.

In the example illustrated in FIGS. 3 and 4, the robot area coverage ratio in the first and second periods is calculated as 33%.

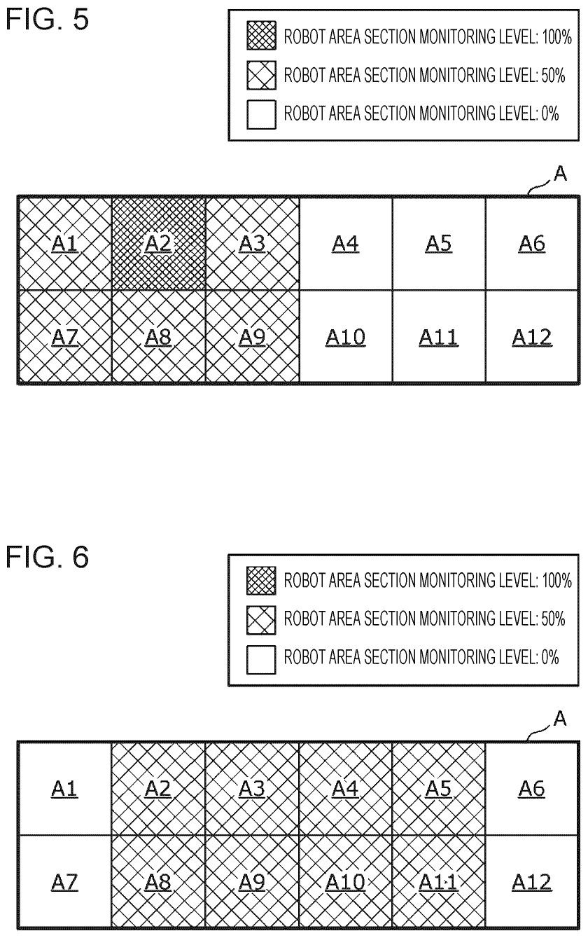

FIGS. 5 and 6 are diagrams illustrating a second example of the monitoring according to the embodiment. Specifically, FIG. 5 is a diagram illustrating the robot area section monitoring levels in the first period. FIG. 6 is a diagram illustrating the robot area section monitoring levels in the second period after images are captured as in the example illustrated in FIG. 5.

In the example illustrated in FIG. 5, in the first period, the robot area section monitoring level of the section A2 is 100%, the robot area section monitoring levels of the sections A1, A3, A7, A8, and A9 are 50%, and the robot area section monitoring levels of the sections A4, A5, A6, A10, A11, and A12 are 0%.

In the example illustrated in FIG. 6, in the second period, the robot area section monitoring levels of the sections A2, A3, A4, A5, A8, A9, A10, and A11 are 50%, and the robot area section monitoring levels of the sections A1, A6, A7, and A12 are 0%.

As described above, in the second example, more images of the section A2 than images of any of the other sections are captured in the first period as in the first example, but in the second period, there is no section whose images are captured more often than any of other sections like the section A2 in the first period. When there is no section whose images are captured more often than any of other sections, the detector 120 determines that an abnormality has occurred in the robot 200 (that is, determines that the robot 200 is abnormal).

In the example illustrated in FIG. 5, the robot area coverage ratio in the first period is calculated as 50%. In the example illustrated in FIG. 6, on the other hand, the robot area coverage ratio in the second period is calculated as 80%. When the robot area coverage ratio is not constant and has changed like this, for example, the detector 120 determines that the robot 200 is abnormal.

Although lines are drawn between adjacent sections in FIGS. 3 to 6 for the sake of description, this does not mean that there are boundary lines in actual space.

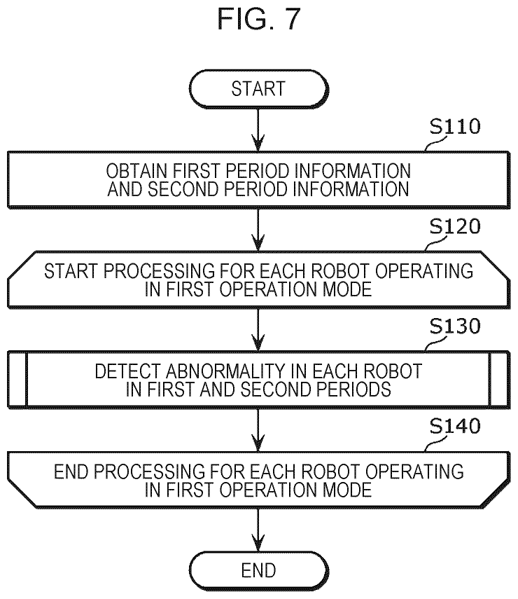

FIG. 7 is a flowchart illustrating a first example of a processing procedure of the abnormality detection system 100 according to the embodiment.

First, the obtainer 110 obtains the first period information and the second period information from each of the one or more robots 200 included in the security system 10 (S110).

Next, the detector 120 starts processing for robots 200 operating in the first operation mode among the one or more robots 200 included in the security system 10 (S120).

Specifically, the detector 120 detects abnormalities in the robots 200 operating in the first operation mode in the first and second periods (S130). More specifically, the detector 120 determines whether each of the one or more robots 200 operating in the first operation mode is abnormal.

After determining whether each of the one or more robots 200 operating in the first operation mode is abnormal, the detector 120 ends the processing for the robots 200 operating in the first operation mode among the one or more robots 200 included in the security system 10 (S140).

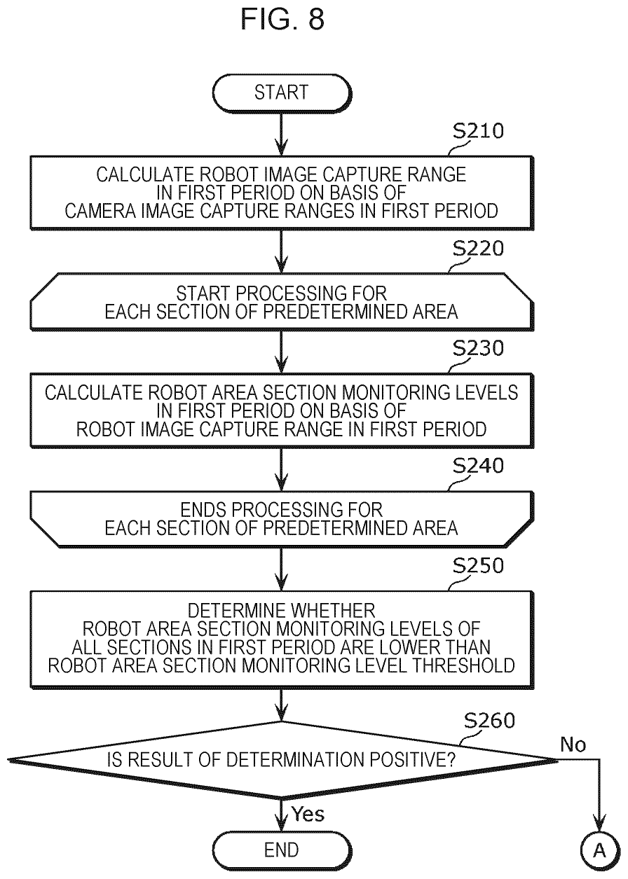

FIGS. 8 to 10 are flowcharts indicating a specific example of a process for determining an abnormality performed by the abnormality detection system 100 according to the embodiment. Specifically, FIGS. 8 to 10 are flowcharts illustrating details of step S130 illustrated in FIG. 7.

First, the detector 120 calculates the robot image capture range in the first period on the basis of the camera image capture ranges in the first period included in the first period information (S210).

Next, the detector 120 starts processing for each of sections of the predetermined area (S220).

Specifically, the detector 120 calculates, for each section, the robot area section monitoring level in the first period on the basis of the robot image capture range in the first period (S230).

After calculating the robot area section monitoring level in the first period for each section, the detector 120 ends the processing for each section of the predetermined area (S240).

Next, the detector 120 determines whether the robot area section monitoring levels of all the sections in the first period are lower than a robot area section monitoring level threshold (S250).

The robot area section monitoring level threshold is a threshold used by the detector 120 in the determination based on the robot area section monitoring level as to whether the robot 200 is continuously monitoring each section.

If a result of the determination in step S250 is positive (Yes in S260), that is, if determining that the robot area section monitoring levels of all the sections in the first period are lower than the robot area section monitoring level threshold, the detector 120 ends the process. That is, in this case, the detector 120 determines that the robot 200 is normal (that is, not abnormal), and ends the process.

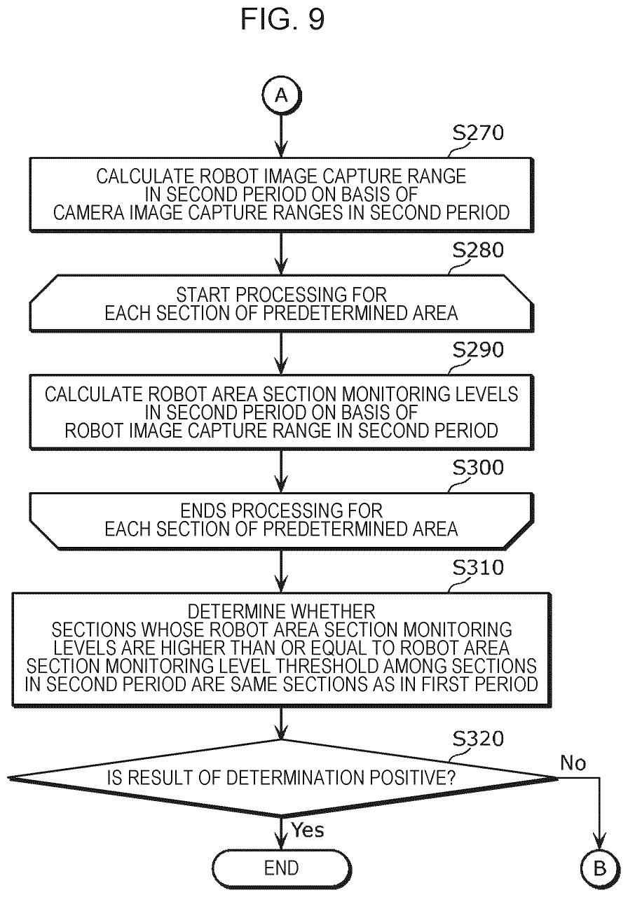

If the result of the determination in step S250 is not positive (No in S260), that is, if at least one of the robot area section monitoring levels of the sections in the first period is higher than or equal to the robot area section monitoring level threshold, on the other hand, the detector 120 causes the process to proceed to step S270 illustrated in FIG. 9.

If a result of step S260 is No, the detector 120 calculates the robot image capture range in the second period on the basis of the camera image capture ranges in the second period included in the second period information (S270).

Next, the detector 120 starts processing for each section of the predetermined area (S280).

Specifically, the detector 120 calculates, for each section, the robot area section monitoring level in the second period on the basis of the robot image capture range in the second period (S290).

After calculating the robot area section monitoring level in the second period for each section, the detector 120 ends the processing for each section of the predetermined area (S300).

Next, the detector 120 determines whether sections whose robot area section monitoring levels are higher than or equal to the robot area section monitoring level threshold among the sections in the second period are the same sections as in the first period (S310).

If a result of the determination in step S310 is positive (Yes in S320), that is, if sections whose robot area section monitoring levels are higher than or equal to the robot area section monitoring level threshold among the sections in the second period are the same sections as in the first period, the detector 120 ends the process. That is, in this case, the detector 120 determines that the robot 200 is normal, and ends the process.

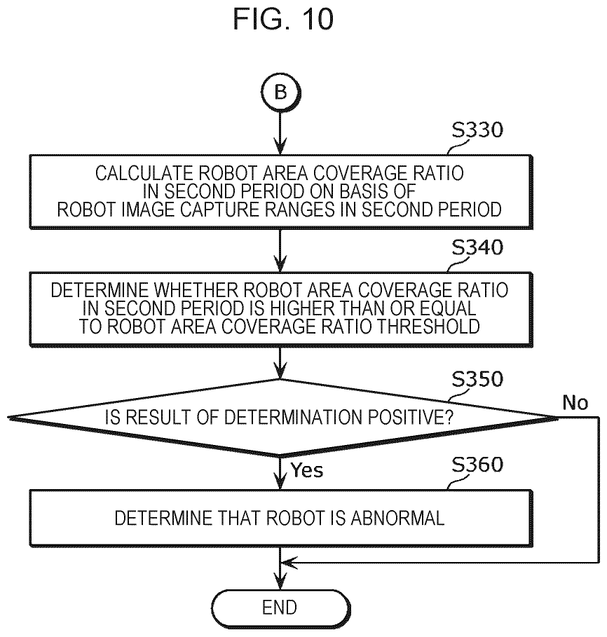

If the result of the determination in step S310 is not positive (No in S320), that is, if the sections whose robot area section monitoring levels are higher than or equal to the robot area section monitoring level threshold among the sections in the second period are not the same as the sections in the first period, on the other hand, the detector 120 causes the process to proceed to step S330 illustrated in FIG. 10.

If a result of step S320 is No, the detector 120 calculates the robot area coverage ratio in the second period on the basis of the robot image capture range in the second period included in the second period information (S330).

Next, the detector 120 determines whether the robot area coverage ratio in the second period is higher than or equal to the robot area coverage ratio threshold (S340).

If a result of the determination in step S340 (Yes in S350), that is, if the robot area coverage ratio in the second period is higher than or equal to the robot area coverage ratio threshold, the detector 120 determines that the robot 200 is abnormal (S360). For example, if the detector 120 determines that the robot 200 is abnormal, that is, if the detector 120 detects an abnormality in the robot 200, the outputter 130 causes the notification device to notify the user that the robot 200 is abnormal, and ends the process.

If the result of the determination in step S340 is not positive (No in S350), that is, if the detector 120 determines that the robot area coverage ratio in the second period is lower than the robot area coverage ratio threshold, that is, if the detector 120 does not detect an abnormality in the robot 200, on the other hand, the detector 120 ends the process, for example, without causing the notification device to notify the user that the robot 200 is abnormal. If the detector 120 determines that the robot 200 is normal, the outputter 130 may cause the notification device to notify the user that the robot 200 is normal.

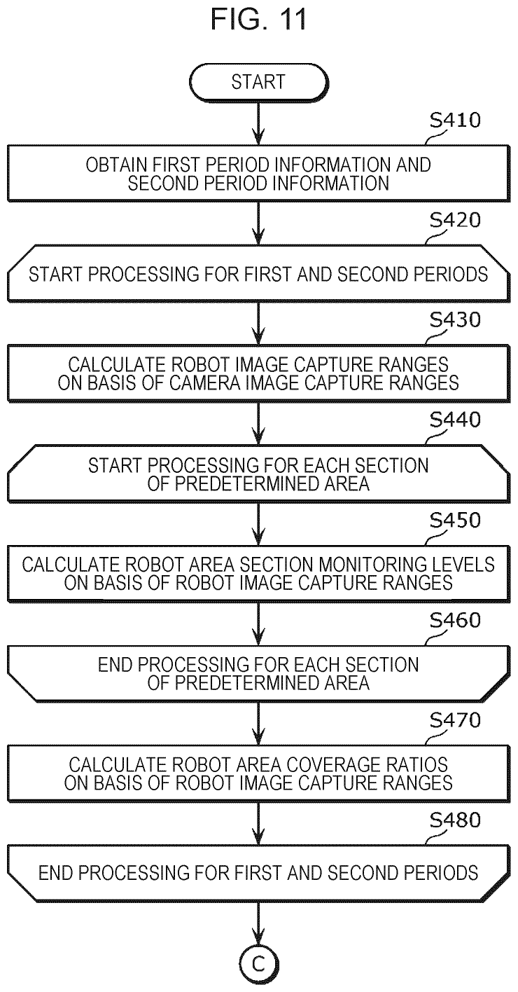

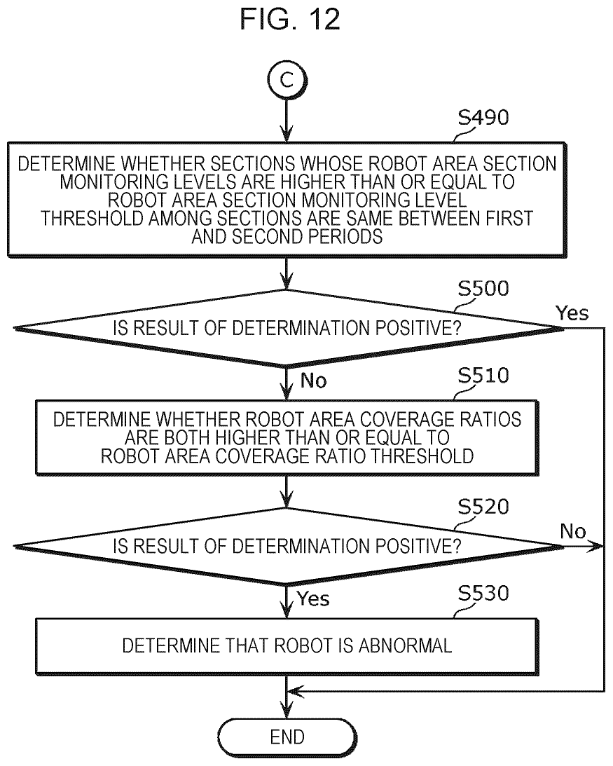

FIGS. 11 and 12 are flowcharts illustrating a second example of the processing procedure of the abnormality detection system 100 according to the embodiment.

First, the obtainer 110 obtains the first period information and the second period information from each of the one or more robots 200 included in the security system 10 (S410).

Next, the detector 120 performs the following process for the robots 200 operating in the first operation mode among the one or more robots 200 included in the security system 10.

The detector 120 starts the process for the first and second periods (S420). Specifically, the detector 120 performs processing in steps S420 to S470.

The detector 120 calculates the robot image capture ranges in the first and second periods on the basis of the camera image capture ranges included in the first and second period information (S430).

Next, the detector 120 starts processing for each section of the predetermined area (S440).

Specifically, the detector 120 calculates, for each section, the robot area section monitoring levels in the first and second periods on the basis of the robot image capture ranges in the first and second periods (S450).

After calculating the robot area section monitoring levels in the first and second periods for each section, the detector 120 ends the processing for each section of the predetermined area (S460).

Next, the detector 120 calculates the robot area coverage ratios in the first and second periods on the basis of the robot image capture ranges in the first and second periods (S470).

After finishing the processing in steps S420 to S470 for the first and second periods, the detector 120 ends the processing for the first and second periods (S480), and causes the process to proceed to step S490 illustrated in FIG. 12.

After step S480, the detector 120 determines whether sections whose robot area section monitoring levels are higher than or equal to the robot area section monitoring level threshold among the sections in the first and second periods are the same between the first period and the second period (S490).

If a result of the determination in step S490 is not positive (No in S500), that is, if it is determined that sections whose robot area section monitoring levels are higher than or equal to the robot area section monitoring level threshold among the sections in the first and second periods are not the same between the first period and the second period, the detector 120 determines whether the robot area coverage ratios in the first and second periods are both higher than or equal to the robot area coverage ratio threshold (S510).

If a result of the determination in step S510 is positive (Yes in S520), that is, if it is determined that the robot area coverage ratios in the first and second periods are both higher than or equal to the robot area coverage ratio threshold, the detector 120 determines that the robot 200 is abnormal (S530).

If the result of the determination in step S490 is positive (Yes in S500), that is, if the sections whose robot area section monitoring levels are higher than or equal to the robot area section monitoring level threshold among the sections in the first and second periods are the same between the first period and the second period, or if the result of the determination in step S510 is not positive (No in S520), that is, if it is determined that at least one of the robot area coverage ratios in the first and second periods is lower than the robot area coverage ratio threshold, on the other hand, the detector 120 ends the process. That is, in this case, the detector 120 determines that the robot 200 is normal.

### Second Operation Mode

Next, an operation of the abnormality detection system 100 in a case where the robot 200 is operating in the second operation mode will be described.

When the robot 200 is operating in the second operation mode, as in the case where the robot 200 is operating in the first operation mode, for example, the detector 120 calculates the robot area coverage ratio indicating the ratio of the camera image capture ranges to the area of the predetermined area on the basis of the first information, and detects an abnormality in the robot 200 on the basis of the robot area coverage ratio.

When the robot 200 is operating in the second operation mode, for example, the detector 120 determines that the robot 200 is normal if the robot area coverage ratio is higher than or equal to a second threshold, and determines that the robot 200 is abnormal if the robot area coverage ratio is lower than the second threshold.

The second threshold may be arbitrarily determined, and is not particularly limited. Information indicating the second threshold is, for example, stored in the storage 150 in advance.

The second threshold is an example of the robot area coverage ratio threshold.

The first and second thresholds may be the same value or different values.

When the robot 200 is operating in the second operation mode, for example, the detector 120 detects an abnormality in the robot 200 on the basis of the first and second information. That is, for example, the detector 120 determines whether the robot 200 is abnormal using information regarding the other cameras (for example, the image capture ranges of the other cameras).

When the robot 200 is operating in the second operation mode, for example, the detector 120 calculates an area coverage ratio indicating a ratio of a total range, which is the sum of the image capture range of the robot camera 210 and the image capture ranges of the other cameras, to the area of the predetermined area on the basis of the first information, and detects an abnormality in the robot 200 on the basis of the area coverage ratio.

The area coverage ratio is an example of a system area coverage ratio.

The area coverage ratio is a ratio of areas whose images have been captured by any of the cameras (the robot camera 210 and the other cameras) included in the security system 10 to the entire predetermined area in the predetermined period.

When the robot 200 is operating in the second operation mode, for example, the detector 120 determines whether the robot 200 is abnormal on the basis of an overlap ratio (also referred to as a “robot image capture range overlap ratio”) indicating a ratio of ranges where the image capture range of the robot camera 210 and the image capture ranges of the other cameras overlap to the image capture range of the robot camera 210.

The overlap ratio is a ratio of area of overlap between a robot image capture range of a single robot 200 and camera image capture ranges of other cameras that are not provided for the robot 200 to area of the robot image capture range of the robot 200. That is, the overlap ratio is a ratio of the camera image capture ranges (area) of the other cameras overlapping the robot image capture range of the robot camera 210 to the robot image capture range (area) of the robot camera 210.

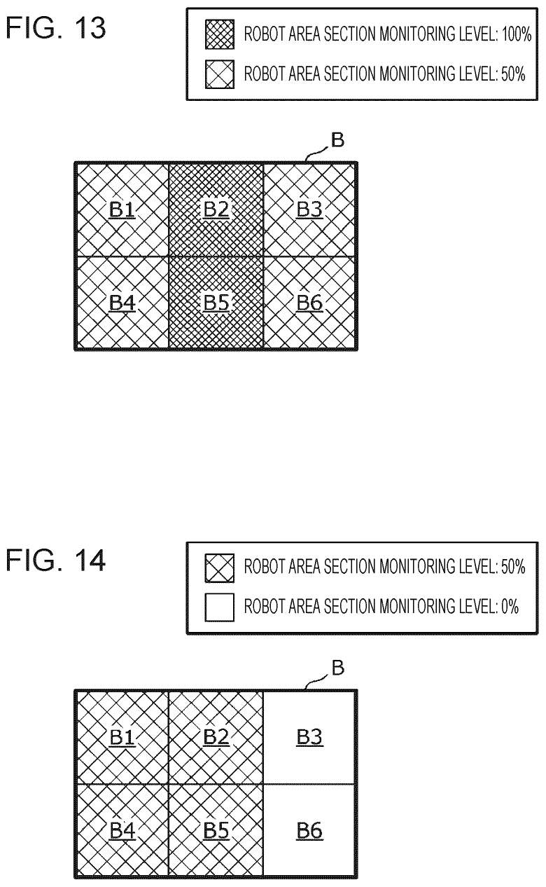

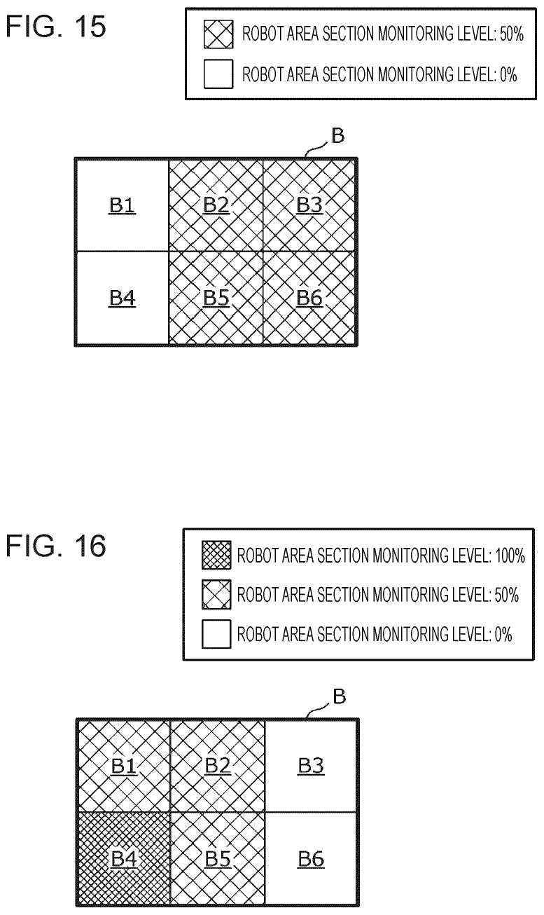

FIGS. 13 to 15 are diagrams illustrating a third example of the monitoring according to the embodiment. Specifically, FIG. 14 is a diagram illustrating robot area section monitoring levels based on the image capture range of the robot camera 210. FIG. 15 is a diagram illustrating robot area section monitoring levels based on an image capture ranges of another camera. In this example, FIG. 15 is a diagram illustrating robot area section monitoring levels based on an image capture range of a robot 200 other than the robot 200 whose abnormality is to be detected. In the third example, the robot 200 whose abnormality is to be detected and the robot 200 other than the foregoing robot 200 capture images of a predetermined area B. FIG. 13 is a diagram illustrating robot area section monitoring levels based on the image capture range of the robot camera 210 and the image capture range of the other camera. That is, FIG. 13 is a diagram illustrating robot area section monitoring levels based on a total range, which is the sum of the image capture range illustrated in FIG. 14 and the image capture range illustrated in FIG. 15.

As illustrated in FIGS. 13 to 15, in this example, the predetermined area B is divided into six sections B1 to B6. For example, each robot 200 captures an image of at least one of the sections B1 to B6 while moving within the predetermined area B. For example, each robot 200 simultaneously captures an image of a plurality of sections such as the sections B1 and B2, or captures an image of only one section such as the section B2.

In the example illustrated in FIG. 13, the robot area section monitoring levels of the sections B2 and B5 are 100%, and the robot area section monitoring levels of the sections B1, B3, B4, and B6 are 50%.

In the example illustrated in FIG. 14, the robot area section monitoring levels of the sections B1, B2, B4, and B5 are 50%, and the robot area section monitoring levels of the sections B3 and B6 are 0%.

In the example illustrated in FIG. 15, the robot area section monitoring levels of the sections B2, B3, B5, and B6 are 50%, and the robot area section monitoring levels of the sections B1 and B4 are 0%.

A section monitoring level calculated from an image capture range of another camera such as the security guard camera 300 or the fixed camera will also be referred to as a robot area section monitoring level.

In the second operation mode, for example, when normal, the robot 200 operates such that the cameras included in the security system 10 capture images of the entirety of the predetermined area B as illustrated in FIG. 13. For this reason, if the predetermined area B is large and it is difficult to capture images of the entirety of the predetermined area B at once using the cameras included in the security system 10, the area coverage ratio increases with the lapse of time.

In the example illustrated in FIG. 13, the area coverage ratio is calculated as 100%.

In the example illustrated in FIG. 14, the robot area coverage ratio is calculated as 66%.

In the example illustrated in FIG. 15, the robot area coverage ratio (another camera area coverage ratio) is calculated as 66%.

In the examples illustrated in FIGS. 14 and 15, the robot image capture range overlap ratio is calculated as 50%.

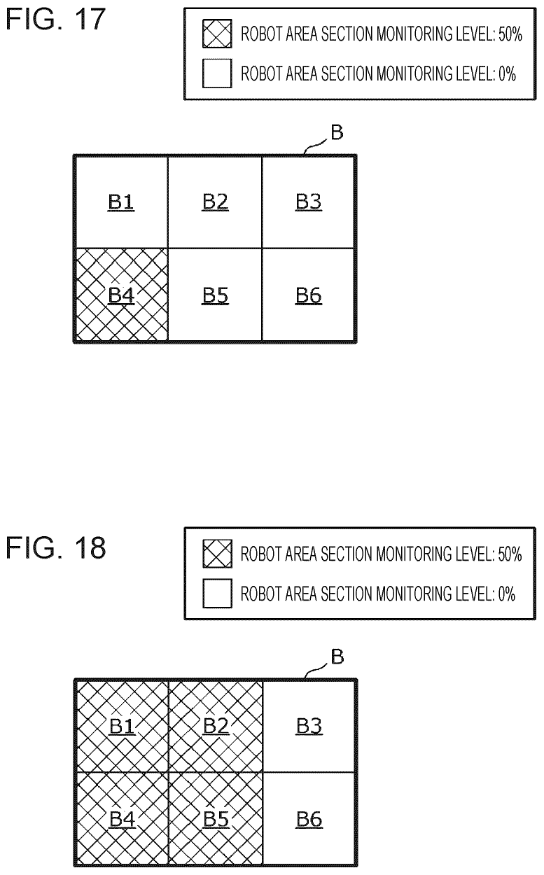

FIGS. 16 to 18 are diagrams illustrating a fourth example of the monitoring according to the embodiment. Specifically, FIG. 17 is a diagram illustrating robot area section monitoring levels based on the image capture range of the robot camera 210. FIG. 18 is a diagram illustrating robot area section monitoring levels based on an image capture range of another camera. In this example, FIG. 18 is a diagram illustrating robot area section monitoring levels based on an image capture range of a robot 200 other than the robot 200 whose abnormality is to be detected. In the fourth example, the robot 200 whose abnormality is to be detected and the robot 200 other than the foregoing robot 200 capture images of the predetermined area B. FIG. 16 is a diagram illustrating robot area section monitoring levels based on the image capture range of the robot camera 210 and the image capture range of the other camera. That is, FIG. 16 is a diagram illustrating robot area section monitoring levels based on a total range, which is the sum of the image capture range illustrated in FIG. 17 and the image capture range illustrated in FIG. 18.

In the example illustrated in FIG. 16, the robot area section monitoring level of the section B4 is 100%, the robot area section monitoring levels of the sections B1, B2, and B5 are 50%, and the robot area section monitoring levels of the sections B3 and B6 are 0%.

In the example illustrated in FIG. 17, the robot area section monitoring level of the section B4 is 50%, and the robot area section monitoring levels of the sections B1, B2, B3, B5, and B6 are 0%.

In the example illustrated in FIG. 18, the robot area section monitoring levels of the sections B1, B2, B4, and B5 are 50%, and the robot area section monitoring levels of the sections B3 and B6 are 0%.

In the example illustrated in FIG. 16, the area coverage ratio is calculated as 66%.

In the example illustrated in FIG. 17, the robot area coverage ratio is calculated as 16%.

In the example illustrated in FIG. 18, the robot area coverage ratio (another camera area coverage ratio) is calculated as 66%.

In the examples illustrated in FIGS. 17 and 18, the robot image capture range overlap ratio is calculated as 100%.

As described above, in the fourth example, the robot area coverage ratio based on the image capture range of the robot camera 210 is lower than in the third example, and the area coverage ratio is also lower than in the third example. When the area coverage ratio does not increase with the lapse of time, for example, the detector 120 determines whether the area coverage ratio is higher than or equal to a predetermined threshold (also referred to as an area coverage ratio threshold), and if the area coverage ratio is higher than or equal to the predetermined threshold, the detector 120 determines that the robot 200 is normal, and if the area coverage ratio is lower than the predetermined threshold, the detector 120 determines that an abnormality has occurred in the robot 200. Alternatively, if the area coverage ratio is lower than the predetermined threshold, the detector 120 further makes a determination whether an abnormality has occurred in the robot 200.

In addition, in the fourth example, the robot image capture range overlap ratio is higher than in the third example. When the area coverage ratio does not increase with the lapse of time, for example, the detector 120 determines whether the robot image capture range overlap ratio is higher than or equal to a predetermined threshold (also referred to as a robot image capture range overlap ratio threshold), and if the robot image capture range overlap ratio is higher than or equal to the predetermined threshold, the detector 120 determines that an abnormality has occurred in the robot 200.

The area coverage ratio threshold and the robot image capture range overlap ratio may be arbitrarily determined, and are not particularly limited. Information indicating the area coverage ratio threshold and the robot image capture range overlap ratio is, for example, stored in the storage 150 in advance.

Although lines are drawn between adjacent sections in FIGS. 13 to 18 for the sake of description, this does not mean that there are partitions in actual space.

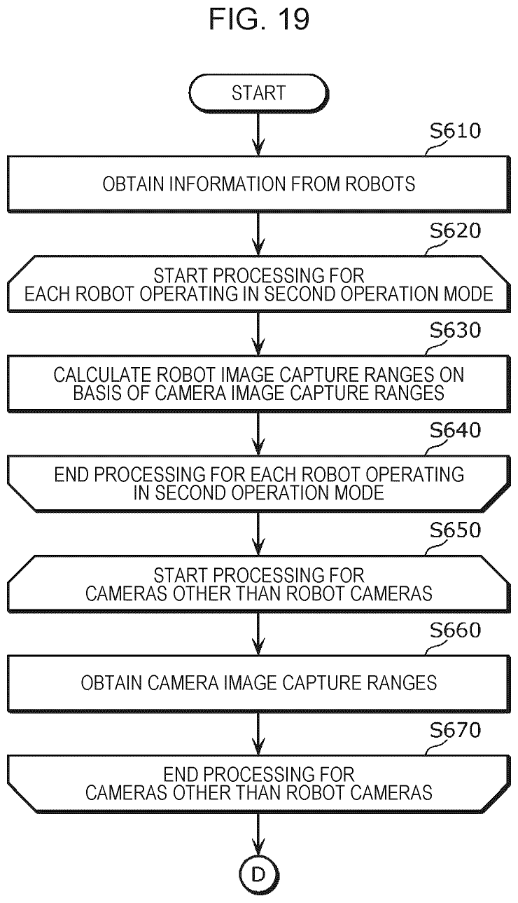

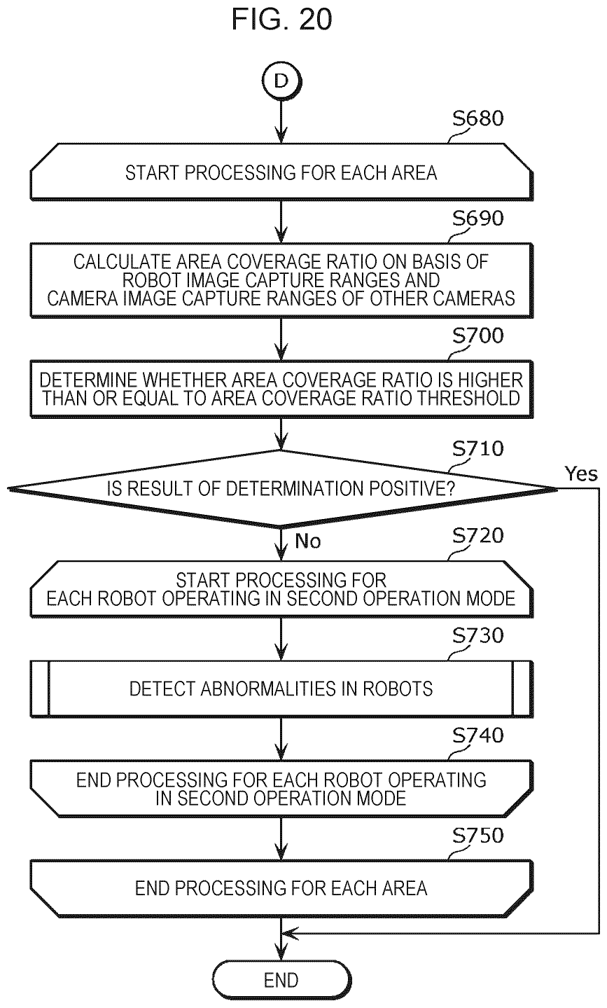

FIGS. 19 and 20 are flowcharts illustrating a third example of the processing procedure of the abnormality detection system 100 according to the embodiment.

First, the obtainer 110 obtains information (the first information or the second information) from the one or more robots 200 included in the security system 10 (S610). Information included in the first information and the second information may be information in the first period, information in the second period, or information in the first and second periods. The following processing is performed on the basis of information in the same period.

Next, the detector 120 starts processing for robots 200 operating in the second operation mode among the one or more robots 200 included in the security system 10 (S620).

Specifically, the detector 120 calculates the robot image capture range of each of the one or more robot 200 on the basis of the camera image capture ranges included in the first information and the second information (S630).

After calculating the robot image capture range of each of the one or more robots 200 operating in the second operation mode, the detector 120 ends the processing for the robots 200 operating in the second operation mode among the one or more robots 200 included in the security system 10 (S640).

Next, the detector 120 starts processing for the cameras included in the security system 10 other than the robot cameras 210 (S650).

Specifically, the obtainer 110 obtains camera image capture ranges (specifically the second information) from the cameras, such as the security guard camera 300 and the fixed camera 400, included in the security system 10 other than the robot cameras 210 and/or the server apparatus 500 (S660).

After obtaining the camera image capture ranges from the cameras included in the security system 10 other than the robot cameras 210 and/or the server apparatus 500, the obtainer 110 ends the processing for the cameras included in the security system 10 other than the robot cameras 210 (S670), and causes the process to proceed to step S680 illustrated in FIG. 20.

After step S670, the detector 120 starts processing for each of areas (S680). For example, the security system 10 might secure a plurality of areas. In this case, the following processing is performed for each of the areas. Specifically, the detector 120 performs processing in steps S690 to S740.

The detector 120 calculates the area coverage ratio on the basis of the robot image capture ranges of the robot cameras 210 and the camera image capture ranges of the other cameras, that is, on the basis of the image capture ranges of the cameras included in the security system 10 (S690).

Next, the detector 120 determines whether the area coverage ratio is higher than or equal to the area coverage ratio threshold (S700).

If a result of the determination in step S700 is positive (Yes in S710), that is, if it is determined that the area coverage ratio is higher than or equal to the area coverage ratio threshold, the detector 120 ends the process. That is, in this case, the detector 120 determines that the robot 200 is normal.

If the result of the determination in step S700 (No in S710), that is, it is determined that the area coverage ratio is not higher than or equal to the area coverage ratio threshold, on the other hand, the detector 120 starts processing for robots 200 operating in the second operation mode among the one or more robots 200 included in the security system 10 (S720).

Specifically, the detector 120 detects abnormalities in the robots 200 operating in the second operation mode (S730). More specifically, the detector 120 determines whether each of the one or more robots 200 operating in the second operation mode is abnormal.

After determining whether each of the one or more robots 200 operating in the second operation mode is abnormal, the detector 120 ends the processing for the robots 200 operating in the second operation mode among the one or more robots 200 included in the security system 10 (S740).

After performing the processing in steps S690 to S740, the detector 120 ends the processing for each area (S750).

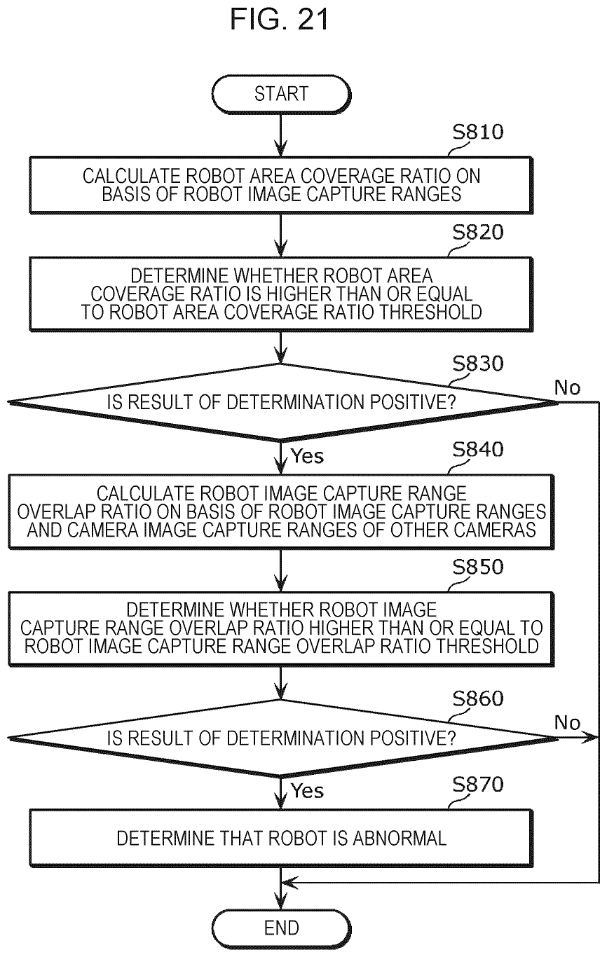

FIG. 21 is a flowchart illustrating another specific example of the process for determining an abnormality performed by the abnormality detection system 100 according to the embodiment. Specifically, FIG. 21 is a flowchart illustrating details of step S730 illustrated in FIG. 20.

First, the detector 120 calculates the robot area coverage ratio on the basis of the robot image capture ranges (S810).

Next, the detector 120 determines whether the robot area coverage ratio is higher than or equal to the robot area coverage ratio threshold (S820).

If a result of the determination in step S820 is positive (Yes in S830), that is, if it is determined that the robot area coverage ratio is higher than or equal to the robot area coverage ratio threshold, the detector 120 calculates the robot image capture range overlap ratio on the basis of the robot image capture ranges of the robots 200 and the camera image capture ranges of the other cameras (S840).

Next, the detector 120 determines whether the robot image capture range overlap ratio is higher than the robot image capture range overlap ratio threshold (S850).

If a result of the determination in step S850 is positive (Yes in S860), that is, if it is determined that the robot image capture range overlap ratio is higher than or equal to the robot image capture range overlap ratio threshold, the detector 120 determines that the robot 200 is abnormal (S870).

If the result of the determination in step S820 is not positive (No in S830), that is, if the robot area coverage ratio is lower than the robot area coverage ratio threshold, or if the result of the determination in step S850 is not positive (No in S860), that is, if it is determined that the robot image capture range overlap ratio is lower than the robot image capture range overlap ratio threshold, on the other hand, the detector 120 ends the process. That is, in this case, the detector 120 determines that the robot 200 is normal.

Alternatively, the detector 120 may perform the process for detecting an abnormality described above for the case where the robots 200 operate in the second operation mode as the process for detecting an abnormality to be performed when the robots 200 operate in the first operation mode. The detector 120 may perform the process for detecting an abnormality described above for the case where the robots 200 operate in the first operation mode as the process for detecting an abnormality to be performed when the robots 200 operate in the second operation mode.

### SUMMARY

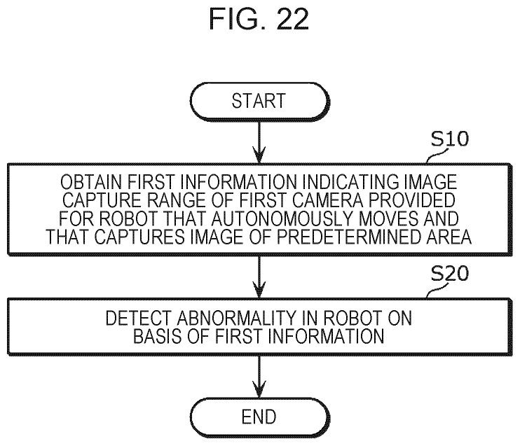

FIG. 22 is a flowchart illustrating a processing procedure of the information processing apparatus according to the embodiment. The abnormality detection system 100 is an example of the information processing apparatus.

First, the information processing apparatus (for example, the obtainer 110) obtains first information indicating an image capture range of a first camera (robot camera 210) provided for a robot 200 that autonomously moves and that captures an image of a predetermined area (S10).

Next, the information processing apparatus (for example, the detector 120) detects an abnormality in the robot 200 on the basis of the first information (S20).

The information processing apparatus includes a processor and a memory, for example, and the processor performs the above process using the memory.

### Effects

Examples of techniques achieved from what is disclosed herein will be described hereinafter, and effects and the like produced from the described techniques will be described.

Technique 1 is an information processing method including obtaining first information indicating an image capture range of a first camera provided for a robot that autonomously moves and that captures an image of a predetermined area (S10), and detecting an abnormality in the robot on a basis of the first information (S20).

The first camera is, for example, the robot camera 210.

A robot 200 that autonomously moves might perform an unexpected operation due to an external cyberattack, a virus, or the like. A robot that secures a predetermined area, such as the robot 200, secures the predetermined area by capturing images of a range according to conditions. In a security service, for example, it is important to “eliminate blind spots”. The present inventors, therefore, have arrived at detection of an abnormality in the robot 200 using not a “position” but a “field of view” of the robot 200, that is, an image capture range of a camera mounted on the robot 200. For example, the robot 200 captures images of the predetermined area in conjunction with other cameras in such a way as to eliminate blind spots, that is, eliminate locations whose image are not captured. Therefore, in an information processing method according to an aspect of the present disclosure, whether the robot 200 is operating in such a way as to eliminate blind spots is monitored. In the information processing method according to the aspect of the present disclosure, for example, the image capture range of the robot camera 210 and an image capture range of a camera (for example, the fixed camera 400) provided inside a facility are overlapped with each other, and it is detected that the robot 200 is abnormal if there is a blind spot. With the information processing method according to the aspect of the present disclosure, abnormal behavior of the robot 200, that is, an abnormality in the robot 200, can thus be detected.

Technique 2 is the information processing method according to Technique 1, in which the robot captures the image of the predetermined area using the first camera by operating in one of a plurality of operation modes including (i) a first operation mode, in which the robot continuously captures, using the first camera, an image of at least one of a plurality of sections included in the predetermined area, and (ii) a second operation mode, in which the robot captures, using the first camera, the image of the predetermined area in accordance with an image capture range of a second camera provided outside the robot, the information processing method further including obtaining operation mode information indicating an operation mode of the robot, in which, in the detecting of an abnormality in the robot, an abnormality in the robot is detected on a basis of the first information and the operation mode information.

The second camera is, for example, the security guard camera 300 or the fixed camera 400.

The first operation mode is, for example, an operation mode in which the robot 200 performs a sentry operation.

The second operation mode is, for example, an operation mode in which the robot 200 performs a mobile sentry operation.

Depending on the operation mode, the robot 200 captures images of the predetermined area differently. In the detecting of an abnormality in the robot 200, therefore, an abnormality is detected by a method according to the operation mode of the robot 200. That is, a determination criterion is changed in accordance with an operation that is being performed by the robot 200. As a result, an abnormality in the robot 200 can be accurately detected.

Technique 3 is the information processing method according to Technique 2, in which the first information includes first period information indicating an image capture range of the first camera in a first period and second period information indicating an image capture range of the first camera in a second period, which is different from the first period, and in which, in the detecting of an abnormality in the robot, when the robot is operating in the first operation mode, an abnormality in the robot is detected on a basis of the first period information and the second period information.

In the sentry operation of the robot 200, when the robot 200 is normal, there is an area section where the robot area section monitoring level is high regardless of the elapse of time, and the robot area coverage ratio is lower than a predetermined value. Therefore, by comparing robot area section monitoring levels or the like calculated on the basis of image capture ranges in two different periods and detecting an abnormality in the robot 200, an abnormality in the robot 200 can be accurately detected.

Technique 4 is the information processing method according to Technique 2 or 3, in which the predetermined area includes a plurality of sections, and in which, in the detecting of an abnormality in the robot, a section monitoring level is calculated for each of the plurality of sections on a basis of the first information, the section monitoring level indicating a ratio of a period for which the first camera has captured an image of the section to a predetermined period, and an abnormality in the robot is detected on a basis of the section monitoring level.

The section monitoring level is, for example, a robot area section monitoring level.

As a result, an abnormality in the robot 200 can be accurately detected.

Technique 5 is the information processing method according to any of Techniques 2 to 4, in which, in the detecting of an abnormality in the robot, a robot area coverage ratio is calculated on a basis of the first information, the robot area coverage ratio indicating a ratio of the image capture range of the first camera to area of the predetermined area, and an abnormality in the robot is detected on a basis of the robot area coverage ratio.

As a result, an abnormality in the robot 200 can be accurately detected.

Technique 6 is the information processing method according to Technique 5, in which, in the detecting of an abnormality in the robot, when the robot is operating in the first operation mode, it is determined that the robot is normal if the robot area coverage ratio is lower than a first threshold, and it is determined that the robot is abnormal if the robot area coverage ratio is higher than or equal to the first threshold.

The first threshold is, for example, a robot area coverage ratio threshold.

As a result, an abnormality in the robot 200 can be accurately detected.

Technique 7 is the information processing method according to Technique 5 or 6, in which, in the detecting of an abnormality in the robot, when the robot is operating in the second operation mode, it is determined that the robot is normal if the robot area coverage ratio is higher than or equal to a second threshold, and it is determined that the robot is abnormal if the robot area coverage ratio is lower than the second threshold.

The second threshold is, for example, a robot area coverage ratio threshold.

As a result, an abnormality in the robot 200 can be accurately detected.

Technique 8 is the information processing method according to any of Techniques 2 to 7, further including obtaining second information indicating the image capture range of the second camera, in which, in the detecting of an abnormality in the robot, when the robot is operating in the second operation mode, an abnormality in the robot is detected on a basis of the first information and the second information.

As described above, for example, the robot 200 captures images of the predetermined area in conjunction with other cameras in such a way as to eliminate blind spots. Therefore, by detecting an abnormality in the robot 200 on the basis of the first information and the second information, an abnormality in the robot 200 can be accurately detected.

The second camera may include a robot camera 210 included in a robot 200 other than the robot 200 whose abnormality is to be detected.

Technique 9 is the information processing method according to Technique 8, in which, in the detecting of an abnormality in the robot, a system area coverage ratio is calculated on a basis of the first information and the second information, the system area coverage ratio indicating a ratio of a total range, which is a sum of the image capture range of the first camera and the image capture range of the second camera, to area of the predetermined area, and an abnormality in the robot is detected on a basis of the system area coverage ratio.

In the mobile sentry operation of the robot 200, when the robot 200 is normal, the system area coverage ratio increases with the lapse of time. When the robot 200 is operating in the second operation mode, therefore, an abnormality in the robot 200 can be accurately detected by detecting an abnormality in the robot 200 on the basis of the system area coverage ratio.

Technique 10 is the information processing method according to Technique 8 or 9, in which, in the detecting of an abnormality in the robot, an overlap ratio indicating a ratio of a range where the image capture range of the first camera and the image capture range of the second camera overlap to the image capture range of the first camera is calculated, and an abnormality in the robot is determined on a basis of the overlap ratio.

The overlap ratio is, for example, a robot image capture range overlap ratio.

As a result, an abnormality in the robot 200 can be accurately detected.

Technique 11 is an information processing apparatus including an obtainer that obtains first information indicating an image capture range of a first camera provided for a robot that autonomously moves and that captures an image of a predetermined area, and a detector that detects an abnormality in the robot on a basis of the first information.

The information processing apparatus is, for example, the abnormality detection system 100.

As a result, the same effects as those produced by the information processing method according to the aspect of the present disclosure are produced.

Technique 12 is a non-transitory computer-readable storage medium storing a program causing a computer to execute the information processing method according to any of Techniques 1 to 11.

As a result, the same effects as those produced by the information processing method according to the aspect of the present disclosure are produced.

### Other Embodiments

Although an embodiment has been described above, the present disclosure is not limited to the above embodiment.

The security system 10 may or may not include the server apparatus 500.

For example, the abnormality detection system 100 described in the above embodiment may be implemented as a single apparatus including all the components, or may be implemented as a plurality of apparatuses to which the functions are distributed and that operates in conjunction with each other.

In the above embodiment, processing performed by a specific processing unit may be performed by another processing unit, instead. Order of a plurality of processing steps may be changed, or a plurality of processing steps may be performed in parallel with each other.

Each device may use any communication standard, and the communication standard used is not particularly limited.

In the above embodiment, each component may be achieved by executing a software program corresponding to the component. Each component may be achieved by reading a software program stored in a storage medium such as a hard disk or a semiconductor memory and executing the software program using a program executer such as a CPU or a processor.

Each component may be achieved by hardware. For example, each component may be a circuit (or an integrated circuit). These circuits may together form a single circuit, or may be discrete circuits. These circuits may be general circuits or dedicated circuits.

General or specific aspects of the present disclosure may be implemented as an apparatus, a system, a method, an integrated circuit, a computer program, a storage medium such as a compact disc read-only memory (CD-ROM), or any selective combination thereof.

The present disclosure also includes modes obtained by modifying each embodiment in various ways conceivable by those skilled in the art and modes achieved by arbitrarily combining components and functions in each embodiment without deviating from the spirit of the present disclosure.

The present disclosure is effective for apparatuses that monitor security robots.

What is claimed is:

1. An information processing method comprising:
obtaining first information indicating an image capture range of a first camera provided for a robot that autonomously moves and that captures an image of a predetermined area; and
detecting an abnormality in the robot on a basis of the first information.

2. The information processing method according to claim 1,
wherein the robot captures the image of the predetermined area using the first camera by operating in one of a plurality of operation modes including (i) a first operation mode, in which the robot continuously captures, using the first camera, an image of at least one of a plurality of sections included in the predetermined area, and (ii) a second operation mode, in which the robot captures, using the first camera, the image of the predetermined area in accordance with an image capture range of a second camera provided outside the robot,
the information processing method further comprising:
obtaining operation mode information indicating an operation mode of the robot,
wherein, in the detecting of an abnormality in the robot, an abnormality in the robot is detected on a basis of the first information and the operation mode information.

3. The information processing method according to claim 2,
wherein the first information includes first period information indicating an image capture range of the first camera in a first period and second period information indicating an image capture range of the first camera in a second period, which is different from the first period, and
wherein, in the detecting of an abnormality in the robot, when the robot is operating in the first operation mode, an abnormality in the robot is detected on a basis of the first period information and the second period information.

4. The information processing method according to claim 2,
wherein the predetermined area includes a plurality of sections, and
wherein, in the detecting of an abnormality in the robot,
a section monitoring level is calculated for each of the plurality of sections on a basis of the first information, the section monitoring level indicating a ratio of a period for which the first camera has captured an image of the section to a predetermined period, and
an abnormality in the robot is detected on a basis of the section monitoring level.

5. The information processing method according to claim 2,
wherein, in the detecting of an abnormality in the robot,
a robot area coverage ratio is calculated on a basis of the first information, the robot area coverage ratio indicating a ratio of the image capture range of the first camera to area of the predetermined area, and
an abnormality in the robot is detected on a basis of the robot area coverage ratio.

6. The information processing method according to claim 5,
wherein, in the detecting of an abnormality in the robot, when the robot is operating in the first operation mode,
it is determined that the robot is normal if the robot area coverage ratio is lower than a first threshold, and
it is determined that the robot is abnormal if the robot area coverage ratio is higher than or equal to the first threshold.

7. The information processing method according to claim 5,
wherein, in the detecting of an abnormality in the robot, when the robot is operating in the second operation mode,
it is determined that the robot is normal if the robot area coverage ratio is higher than or equal to a second threshold, and
it is determined that the robot is abnormal if the robot area coverage ratio is lower than the second threshold.

8. The information processing method according to claim 2, further comprising:
obtaining second information indicating the image capture range of the second camera,
wherein, in the detecting of an abnormality in the robot, when the robot is operating in the second operation mode, an abnormality in the robot is detected on a basis of the first information and the second information.

9. The information processing method according to claim 8,
wherein, in the detecting of an abnormality in the robot,
a system area coverage ratio is calculated on a basis of the first information and the second information, the system area coverage ratio indicating a ratio of a total range, which is a sum of the image capture range of the first camera and the image capture range of the second camera, to area of the predetermined area, and
an abnormality in the robot is detected on a basis of the system area coverage ratio.

10. The information processing method according to claim 8,
wherein, in the detecting of an abnormality in the robot,
an overlap ratio indicating a ratio of a range where the image capture range of the first camera and the image capture range of the second camera overlap to the image capture range of the first camera is calculated, and
an abnormality in the robot is determined on a basis of the overlap ratio.

11. An information processing apparatus comprising:
an obtainer that obtains first information indicating an image capture range of a first camera provided for a robot that autonomously moves and that captures an image of a predetermined area; and
a detector that detects an abnormality in the robot on a basis of the first information.

12. A non-transitory computer-readable storage medium storing a program causing a computer to execute the information processing method according to claim 1.
